(19) United States
(12) Patent Application Publication
(10) Pub. No.: US 2014/0354400 A1
(43) Pub. Date: Dec. 4, 2014

(54) SYSTEM FOR MANAGING ENTRY AND EXIT OF VEHICLES

(71) Applicant: Dong Yang Solution Co. Ltd., Seoul (KR)

(72) Inventors: Jeong Hun SEO, Seoul (KR); Dal Won LEE, Seoul (KR)

(73) Assignee: Dong Yang Solution Co. Ltd., Seoul (KR)

(21) Appl. No.: 14/291,431

(22) Filed: May 30, 2014

(30) Foreign Application Priority Data
Jun. 4, 2013 (KR) 10-2013-0063910

(51) Int. Cl. G07C 9/00

(52) U.S. Cl. CPC G07C 9/00111
USPC 340/5.7

(57) ABSTRACT

A system for managing the entry and exit of vehicles is disclosed. The system for managing entry and exit of vehicles includes at least one entering vehicle information reader for correcting Global Positioning System (GPS) location coordinates obtained from signals received through a GPS antenna, based on location coordinate error information transmitted in a wireless manner from a correction base station, setting information of corrected GPS location coordinates to location information of a vehicle in an open storage yard, and transmitting the vehicle location information, together with entering vehicle information detected upon scanning vehicle information, in a wireless manner. A management server displays the entering vehicle information and the vehicle location information in the open storage yard, received from the at least one entering vehicle information reader, on a status board capable of separately displaying information depending on vehicle parking zones.

### BACKGROUND OF THE INVENTION

1. Field of the Invention

The present invention relates, in general, to a system for managing the entry and exit of vehicles and, more particularly, to a system for managing the entry and exit of vehicles, which manage a vehicle entry and exit process for entering vehicles in an open storage yard, exiting the vehicles from the open storage yard, and shipping the vehicles on a vessel or the like.

2. Description of the Related Art

A vehicle storage field, that is, an open storage yard, in which a plurality of vehicles waiting to be released or exported are stored, has an area, the width and length sizes of which range from a minimum of several hundreds of meters to a maximum of several kilometers. Such a vehicle storage field is subdivided into a plurality of several tens of parking zones (also called parking blocks). In each parking zone, a plurality of vehicles are stored. In particular, in a parking zone, the width and length sizes of which reach 1 kilometer, about forty thousand vehicles are stored.

Most vehicles stored in such a vehicle parking zone are transferred to different regions, and so they must be classified by the type/transfer region of vehicles and stored at designated locations in order for such vehicles to be easily located. In most current vehicle storage fields, the management of locations of vehicles and the management of stored vehicles (the stock) are performed by referring to documents created during the entry/exit of vehicles and details manually written and entered by part-time workers while surveying the fields, thus wasting human and temporal resources.

As technology for solving this problem, there is technology filed and published by the present application and entitled “Tag transmitter and vehicle location tracking system using the tag transmitter.” The technology discloses a system for producing a Global Positioning System (GPS) and a tag function for identifying vehicles in the form of a single small-sized tag so as to determine the locations of the vehicles, thus allowing the locations of vehicles desired by a manager to be easily determined in a very expansive vehicle storage field. In such a system, a plurality of tag transmitters must be mounted in respective vehicles, wherein each of the tag transmitters is operated by driving power supplied with the driving of the engine of a vehicle, has its own identification information, receives GPS signals, calculates a current location, and transmits a location signal including the calculated location information and the identification information in a wireless manner. Therefore, tag transmitters must be mounted in all vehicles, thus resulting in a delay in a production process and also becoming a factor increasing production costs.

Furthermore, the system disclosed in the above conventional technology merely conveniently provides only necessary location information so as to enter and exit vehicles in and from an open storage yard. Vehicles stored in an open storage yard must be typically shipped on a vessel or the like. Even in this shipping process, a worker must personally intervene in checking individual vehicles to be shipped, thus also wasting human and temporal resources, as described above.

Therefore, if the management of the entry and exit of all vehicles can be more efficiently performed and even partially automated upon the entering of vehicles to be stored in an open storage yard and the exiting of stored vehicles from the open storage yard, and shipping the vehicles on a vessel or the like, it is determined that the waste of human and temporal resources that are unnecessarily consumed can be minimized.

### SUMMARY OF THE INVENTION

Accordingly, the present invention has been made keeping in mind the above problems occurring in the prior art, and an object of the present invention is to provide a system for managing the entry and exit of vehicles, which supports vehicle management by not only managing vehicles so that the location information and characteristic information of vehicles that enter an open storage yard can be precisely detected and checked, but also managing the vehicles so that vehicles that exit the open storage yard and are shipped on a vessel or the like can be automatically detected and can then be conveniently managed in an integrated manner.

Another object of the present invention is to provide a system for managing the entry and exit of vehicles, which can provide an integrated vehicle management tool for not only managing vehicles that enter and exit an open storage yard, but also managing vehicles that exit the open storage yard and are shipped on a vessel or the like, by investing a minimum of manpower and resources.

A further object of the present invention is to provide a system for managing the entry and exit of vehicles, which has the function of filtering vehicles that enter and exit an open storage yard and vehicles that are shipped, thus automatically filtering vehicles that abnormally enter the open storage yard and vehicles that are abnormally shipped on a vessel.

In order to accomplish the above objects, a system for managing entry and exit of vehicles according to an embodiment of the present invention includes at least one entering vehicle information reader for correcting Global Positioning System (GPS) location coordinates obtained from signals received through a GPS antenna, based on location coordinate error information transmitted in a wireless manner from a correction base station, setting information of corrected GPS location coordinates to location information of a vehicle in an open storage yard, and transmitting the vehicle location information, together with entering vehicle information detected upon scanning vehicle information, in a wireless manner; and a management server for displaying the entering vehicle information and the vehicle location information in the open storage yard, received from the at least one entering vehicle information reader, on a status board capable of separately displaying information depending on vehicle parking zones.

The system for managing entry and exit of vehicles according to another embodiment of the present invention may further include at least one exiting vehicle information reader installed in an exit zone of the open storage yard and configured to transmit exiting vehicle information, detected upon scanning vehicle information, to the management server, wherein the management server displays exiting vehicles on the status board based on received exiting vehicle information.

The system for managing entry and exit of vehicles according to a further embodiment of the present invention system may further include a vehicle detection unit for detecting vehicles at a shipping location of vehicles exiting the open storage yard; and a shipped vehicle information acquisition unit for acquiring shipped vehicle information upon detecting the vehicles and transmitting the shipped vehicle information to the management server, wherein the management server displays shipped vehicles on the status board based on received shipped vehicle information.

The system for managing entry and exit of vehicles according to yet another embodiment of the present invention may further include a correction base station provided at previously measured location coordinates and configured to calculate location coordinate error information by comparing GPS location coordinates obtained from signals received from GPS satellites with the previously measured location coordinates and to transmit the location coordinate error information to the vehicle information readers in a wireless manner; and at least one access point configured to relay information transmitted and received between the entering vehicle information reader and the management server, or between the exiting vehicle information reader and the management server, or between the shipped vehicle information acquisition unit and the management server.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a configuration required to manage the entry of vehicles in an open storage yard in a system for managing the entry and exit of vehicles according to an embodiment of the present invention;

FIG. 2 is a diagram showing a configuration required to manage the shipping of vehicles on a vessel in the system for managing the entry and exit of vehicles according to an embodiment of the present invention;

FIG. 3 is a flowchart showing a vehicle entry procedure, a vehicle exit procedure, and a vehicle shipping procedure sequentially performed by the system for managing the entry and exit of vehicles according to an embodiment of the present invention; and

FIG. 4 is a diagram showing a procedure for correcting GPS location coordinates in FIG. 3.

### DESCRIPTION OF THE PREFERRED EMBODIMENTS

Hereinafter, embodiments of the present invention will be described in detail with reference to the attached drawings.

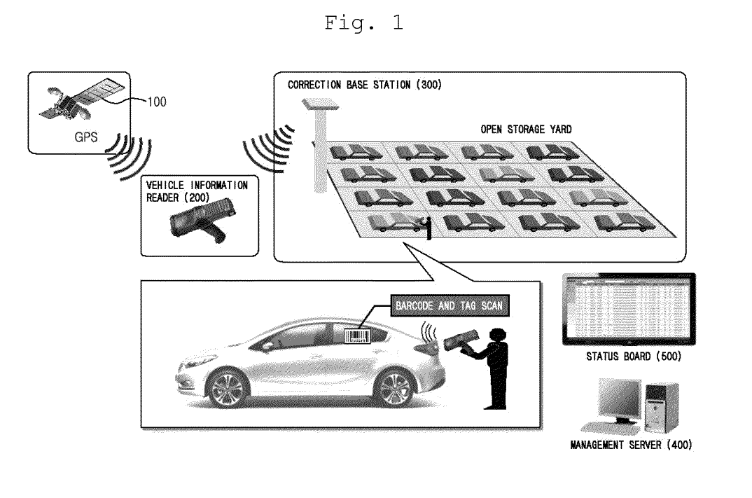

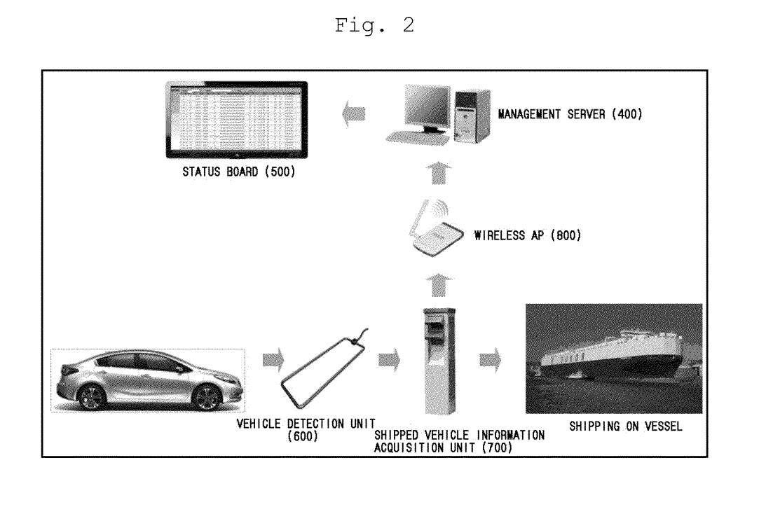

FIG. 1 is a diagram showing a configuration required to manage the entry of vehicles in an open storage yard in a system for managing the entry and exit of vehicles according to an embodiment of the present invention, and FIG. 2 is a diagram showing a configuration required to manage the shipping of vehicles on a vessel in the system for managing the entry and exit of vehicles according to an embodiment of the present invention.

Referring to FIG. 1, a vehicle information reader 200 corrects Global Positioning System (GPS) location coordinates obtained from signals received from one or more GPS satellites 100 through a GPS antenna, based on location coordinate error information transmitted in a wireless manner from a correction base station 300, sets the information of the corrected GPS location coordinates to the location information of each vehicle in an open storage yard (for example, the current location coordinates of the vehicle), and transmits the vehicle location information, together with entering vehicle information detected upon scanning vehicle information (for example, barcode labels attached to the windows of vehicles), to a management server 400, which will be described later, in a wireless manner. Depending on the purpose of use, the vehicle information reader 200 may be designated as an ‘entering vehicle information reader’ upon detecting the information of entering vehicles, and as an ‘exiting vehicle information reader’ upon detecting the information of exiting vehicles. For reference, the vehicle information reader 200 is a portable terminal that can be carried by a vehicle management worker in the open storage yard, and may be implemented as a portable wireless barcode reader or a portable wireless Radio Frequency (RF) tag reader.

Even if the vehicle information reader 200 is used as the exiting vehicle information reader, the vehicle information reader 200 receives error information from a correction base station 300, which will be described later, corrects GPS location coordinates obtained from the terminal, sets the information of the corrected GPS location coordinates to the current location information of each vehicle in the open storage yard, and transmits the current vehicle location information, together with exiting vehicle information detected upon scanning the information of vehicles to exit (for example, barcode labels attached to the windows of the vehicles), to the management server 400.

When the vehicle information reader 200 is not used as the exiting vehicle information reader, the information of vehicles that exit the open storage yard may be simply acquired through a reader which is installed in the exit zone of the open storage yard and which can scan the labels attached to the windows of vehicles. That is, the system for managing the entry and exit of vehicles may be configured to further include an exiting vehicle information reader installed in the exit zone of the open storage yard and configured to transmit exiting vehicle information, detected upon scanning vehicle information (for example, barcode labels attached to windows), to the management server 400.

Meanwhile, the correction base station 300 is provided or installed at previously measured location coordinates and configured to compare GPS location coordinates obtained from signals received from the GPS satellites 100 with the previously measured location coordinates, calculate location coordinate error information, and transmit the location coordinate error information to a plurality of vehicle information readers 200 in a wireless manner. As is well-known in the art, the correction base station 300 may be implemented as a Differential GPS (DGPS) for storing absolute location values (previously measured location coordinates). For reference, a plurality of correction base stations 300 may be provided in corresponding open storage yards, respectively, in consideration of wireless communication distances to the vehicle information readers 200, and may be interposed between neighboring open storage yards.

The management server 400, which is the main computer of the system for managing the entry and exit of vehicles, displays the entering vehicle information and the location information of vehicles in each open storage yard, transmitted from one or more entering vehicle information readers 200, on a status board 500 capable of separately displaying information depending on vehicle parking zones. Such a management server 400 also receives exiting vehicle information transmitted from exiting vehicle information readers, displays exiting vehicles on the status board 500, and additionally displays shipped vehicles on the status board 500 based on shipped vehicle information transmitted from a shipped vehicle information acquisition unit.

Furthermore, the management server 400 may additionally provide the filtering function of detecting abnormally entering vehicles and providing a warning against the abnormally entering vehicles when vehicles to enter other transfer regions are abnormally entering each of the open storage yards classified by transfer region. For this, in the management server 400, the information of vehicles to enter respective open storage yards must be previously registered, and the information of vehicles required to be previously registered is received from the servers of vehicle manufacturers or the servers of vehicle transport companies and then stored. Of course, in consideration of even the case where vehicles are shipped, the management server 400 may filter vehicles prohibited from being shipped and provide a warning against the vehicles. For reference, the management server 400 may be connected to the servers (not shown) of external institutions (for example, export companies, vehicle manufacturers, and vehicle transport companies) through leased lines so as to previously register the information of entering vehicles or shipped vehicles.

Meanwhile, as shown in FIG. 2, the system for managing the entry and exit of vehicles according to an embodiment of the present invention may further include a vehicle detection unit 600 and a shipped vehicle information acquisition unit 700. The vehicle detection unit 600 detects vehicles at the shipping location (for example, the entrance of the car deck of a vessel) of vehicles that exited the open storage yard. The shipped vehicle information acquisition unit 700 acquires shipped vehicle information (for example, barcode labels attached to the windows of vehicles) when vehicles are detected by the vehicle detection unit 600, and transmits the shipped vehicle information to the management server 400. The vehicle detection unit 600 may be implemented as an axle-load detector buried in a vehicle movement path. The shipped vehicle information acquisition unit 700 may be implemented as, for example, a reader for scanning barcode labels attached to the side windows of vehicles, or may acquire shipped vehicle information in such a way that a camera simply captures images of barcode labels and the management server 400 utilizes a recognition algorithm capable of recognizing barcode labels from the captured images.

Depending on the circumstances, the system for managing the entry and exit of vehicles may be configured to further include one or more access points for relaying information transmitted and received between the entering vehicle information readers 200 and the management server 400, or between the exiting vehicle information readers and the management server 400, or between the shipped vehicle information acquisition unit 700 and the management server 400 in consideration of communication distances between the above components.

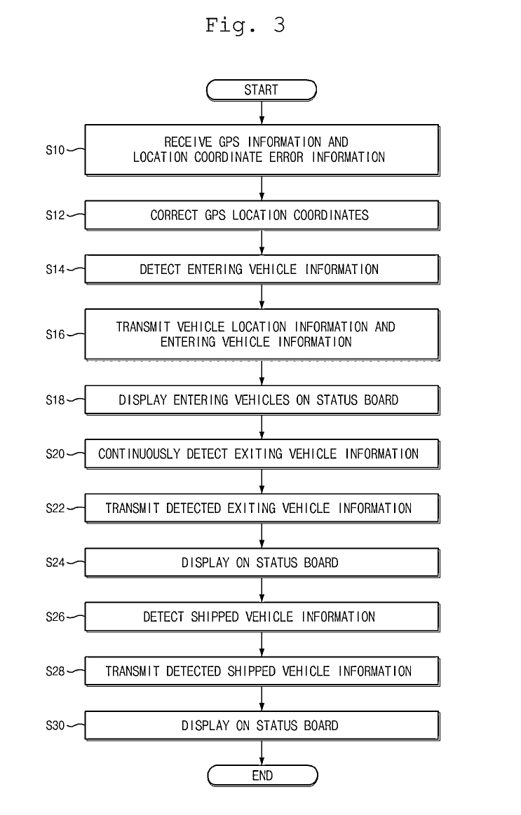

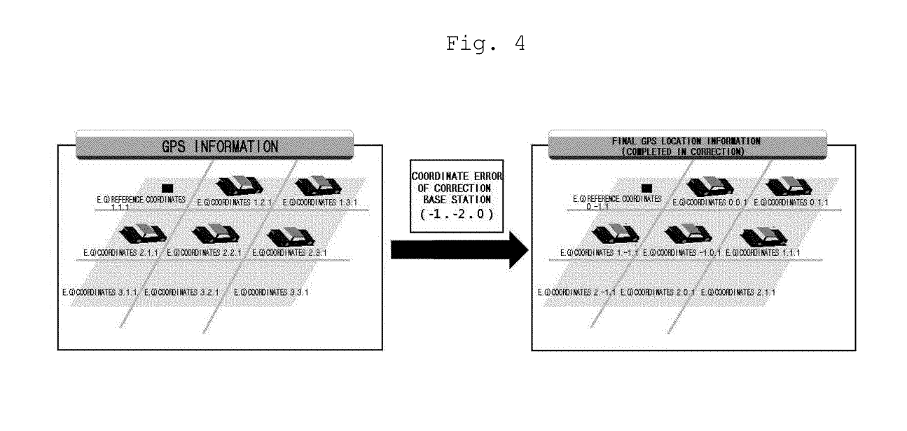

Below, the operation of the system for managing the entry and exit of vehicles, having the above-described configuration, will be additionally described in detail with reference to FIGS. 3 and 4.

FIG. 3 is a flowchart showing a vehicle entry procedure, a vehicle exit procedure, and a vehicle shipping procedure sequentially performed by the system for managing the entry and exit of vehicles according to an embodiment of the present invention, and FIG. 4 is a diagram showing a procedure for correcting GPS location coordinates in FIG. 3.

Referring to FIG. 3, when a worker who managers vehicles entering an open storage yard operates an entering vehicle information reader 200, the entering vehicle information reader 200 receives GPS information through a GPS antenna, and receives location coordinate error information from the correction base station 300 at step S10. As described above, the ‘location coordinate error information’ is calculated by comparing GPS location coordinates obtained from signals received from GPS satellites 100 with previously measured location coordinates (absolute location values). In the following description, the location coordinate error information is assumed to have values of (−1, −2, 0), as shown in FIG. 4.

The control unit of the entering vehicle information reader 200 that received the location coordinate error information corrects the GPS location coordinates (GPS information), obtained from the signals received through the GPS antenna, based on the location coordinate error information transmitted in a wireless manner from the correction base station 300, at step S12. As shown in FIG. 4, a correction method at this time may be implemented using a method of simply subtracting the location coordinate error information from the GPS location coordinates. In this case, when the acquired GPS location coordinates are (1,2,1), GPS location coordinates corrected using the location coordinate error information (−1,−2,0) are (0,0,1).

If the correction of the GPS location coordinates is internally performed, and the information of each entering vehicle is detected by the manipulation of a worker (manipulation of scanning barcodes) at step S14, the control unit of the entering vehicle information reader 200 sets the information of the GPS location coordinates corrected at step S12 to the current location information of each vehicle in the open storage yard, and transmits the current vehicle location information together with the detected entering vehicle information in a wireless manner at step S16. The information transmitted in the wireless manner is transferred to the management server 400 through a wireless access point.

Then, the management server 400 displays the information of entering vehicles received from one or more entering vehicle information readers 200 and the location information of the corresponding vehicles in the open storage yard on a status board capable of separately displaying information depending on vehicle parking zones at step S18. In this way, when the worker scans the corresponding entered vehicle information while surveying the vehicles stored (parked) in the open storage yard, the management server 400 receives the information of each entered vehicle and the current vehicle location information of the entered vehicle, and displays the received information on the status board 500. Therefore, the manager of the management server 400 may conveniently determine whether vehicles to enter the open storage yard are normally entering the open storage yard, or whether the entry of the vehicles in the open storage yard has been completed.

In the case where the function of filtering abnormally entering vehicles is provided, the management server 400 checks whether the information of entered vehicles previously registered for respective open storage yards matches the information of vehicles that are entering the open storage yards in real time. If vehicles are abnormally entering the open storage yards, the management server 400 provides a warning against the abnormally entering vehicles, and thus the manager may lead the abnormally entering vehicles to be moved to normal open storage yards.

In the state in which vehicles that have entered the respective open storage yards are stored, for example, if shipping on a vessel is required, the vehicles stored in the respective open storage yards must undergo an exit process. The exit of the stored vehicles is monitored using exiting vehicle information readers, and the exiting vehicle information readers at this time are assumed to be simply installed in the exit zones of respective open storage yards.

That is, if each exiting vehicle has passed through the corresponding exit zone, the information of exiting vehicles may be continuously detected by the corresponding exiting vehicle information reader located in the exit zone. Of course, the information of exiting vehicles may also been obtained using a method of scanning barcode labels attached to the windows of vehicles via a portable exiting vehicle information reader. In this way, when the portable exiting vehicle information reader is used, the location information of the vehicles is also transmitted together, and thus even the situation of the movement of vehicles in the open storage yard may be checked.

As described above, when the information of the exiting vehicles is continuously detected at step S20, the detected exiting vehicle information is also transmitted in a wireless manner through the exiting vehicle information readers at step S22, and the exiting vehicle information is transferred to the management server 400 through the wireless access points. In this way, the management server 400 displays the exiting vehicles on the status board 500 based on the received exiting vehicle information at step S24. Further, the manager may conveniently check whether vehicles that entered each open storage yard are normally exiting the open storage yard or whether the exit of the vehicles has been completed, via the status board 500.

If the vehicles that exited the open storage yard are moved to a vessel docking at a wharf to be subsequently shipped, the vehicle detection unit 600, such as an axle-weight detector, detects shipped vehicles at the shipping location of the vehicles that exited the open storage yard. If the shipped vehicles are detected, the shipped vehicle information acquisition unit 700 captures images of the barcode labels attached to the side windows of the vehicles, recognizes the barcodes, and detects the information of the shipped vehicles at step S26. Further, the detected shipped vehicle information is transmitted to the management server 400 at step S28, and thus the management server 400 displays the shipped vehicles on the status board 500 based on the received shipped vehicle information at step S30. If a shipped vehicle filtering function is provided, the management server 400 checks whether the information of shipped vehicles previously registered for each vessel matches the information of vehicles that are being shipped in real time on the vessel, and may provide a warning against the abnormally shipped vehicles to the manager if the vehicles are abnormally shipped.

As described above, since the system for managing the entry and exit of vehicles according to embodiments of the present invention may acquire the location information and the characteristic information of vehicles stored in each open storage yard through each entering vehicle information reader, and display the acquired information on a status board or the like, there is an advantage in that, even if minimum resources are invested, vehicles stored in the open storage yard can be efficiently managed, and in that an entering vehicle information reader can also be used as an exiting vehicle information reader, and thus the cost of constructing the entry/exit management system for the open storage yard can be minimized.

Further, the present invention is advantageous in that when vehicles exiting an open storage yard are shipped on a vessel or the like, the information of the shipped vehicles is automatically detected and is automatically displayed on a status board or the like, so that not only the management of vehicles entering and exiting an open storage yard, but also the management of vehicles that exited the open storage yard and that are shipped on a vessel or the like may be conveniently performed in an integrated manner by investing only minimum manpower and resources.

Furthermore, the present invention is advantageous in that vehicles abnormally entering an open storage yard and vehicles abnormally shipped on a vessel may be filtered, thus facilitating the management of entering and exiting vehicles and shipped vehicles.

Furthermore, the present invention is advantageous in that it has the function of filtering vehicles entering/exiting an open storage yard and vehicles shipped on a vessel, so that vehicles abnormally entering the open storage yard and vehicles abnormally shipped on a vessel may be filtered, thus facilitating the management of entering and exiting vehicles and shipped vehicles.

Although the present invention has been described with reference to the embodiments illustrated in the drawings, those skilled in the art will appreciate that these embodiments are merely exemplary and various modifications and other equivalent embodiments are possible from the embodiments. Therefore, the technical scope of the present invention should be defined by the accompanying claims.

What is claimed is:

1. A system for managing entry and exit of vehicles, comprising:
at least one entering vehicle information reader for correcting Global Positioning System (GPS) location coordinates obtained from signals received through a GPS antenna, based on location coordinate error information transmitted in a wireless manner from a correction base station, setting information of corrected GPS location coordinates to location information of a vehicle in an open storage yard, and transmitting the vehicle location information, together with entering vehicle information detected upon scanning vehicle information, in a wireless manner; and
a management server for displaying the entering vehicle information and the vehicle location information in the open storage yard, received from the at least one entering vehicle information reader, on a status board capable of separately displaying information depending on vehicle parking zones.

2. The system of claim 1, further comprising at least one exiting vehicle information reader installed in an exit zone of the open storage yard and configured to transmit exiting vehicle information, detected upon scanning vehicle information, to the management server,
wherein the management server displays exiting vehicles on the status board based on received exiting vehicle information.

3. The system of claim 1, further comprising at least one exiting vehicle information reader for setting information of the corrected GPS location coordinates to location information of each vehicle in the open storage yard, and transmitting the vehicle location information, together with exiting vehicle information detected upon scanning vehicle information, to the management server,
wherein the management server displays exiting vehicles on the status board based on received exiting vehicle information.

4. The system of claim 3, wherein the entering vehicle information reader and the exiting vehicle information reader are identical terminals, each reader being either a portable wireless barcode reader or a portable wireless Radio Frequency (RF) tag reader.

5. The system of claim 3, further comprising:
a vehicle detection unit for detecting vehicles at a shipping location of vehicles exiting the open storage yard; and
a shipped vehicle information acquisition unit for acquiring shipped vehicle information upon detecting the vehicles and transmitting the shipped vehicle information to the management server,
wherein the management server displays shipped vehicles on the status board based on received shipped vehicle information.

6. The system of claim 5, further comprising:
a correction base station provided at previously measured location coordinates and configured to calculate location coordinate error information by comparing GPS location coordinates obtained from signals received from GPS satellites with the previously measured location coordinates and to transmit the location coordinate error information to the vehicle information readers in a wireless manner; and
at least one access point configured to relay information transmitted and received between the entering vehicle information reader and the management server, or between the exiting vehicle information reader and the management server, or between the shipped vehicle information acquisition unit and the management server.

7. The system of claim 3, further comprising:
a correction base station provided at previously measured location coordinates and configured to calculate location coordinate error information by comparing GPS location coordinates obtained from signals received from GPS satellites with the previously measured location coordinates and to transmit the location coordinate error information to the vehicle information readers in a wireless manner; and
at least one access point for relaying information transmitted and received between the entering vehicle information reader and the management server or between the exiting vehicle information reader and the management server.

8. The system of claim 2, further comprising:
a vehicle detection unit for detecting vehicles at a shipping location of vehicles exiting the open storage yard; and
a shipped vehicle information acquisition unit for acquiring shipped vehicle information upon detecting the vehicles and transmitting the shipped vehicle information to the management server,
wherein the management server displays shipped vehicles on the status board based on received shipped vehicle information.

9. The system of claim 2, further comprising:
a correction base station provided at previously measured location coordinates and configured to calculate location coordinate error information by comparing GPS location coordinates obtained from signals received from GPS satellites with the previously measured location coordinates and to transmit the location coordinate error information to the vehicle information readers in a wireless manner; and
at least one access point for relaying information transmitted and received between the entering vehicle information reader and the management server or between the exiting vehicle information reader and the management server.

10. The system of claim 1, further comprising:
a correction base station provided at previously measured location coordinates and configured to calculate location coordinate error information by comparing GPS location coordinates obtained from signals received from GPS satellites with the previously measured location coordinates and to transmit the location coordinate error information to the vehicle information readers in a wireless manner; and
at least one access point for relaying information transmitted and received between the entering vehicle information reader and the management server.

11. The system of claim 1, wherein the management server checks whether information of entered vehicles previously registered for each open storage yard matches information of vehicles that are entering the open storage yard in real time, and provides a warning against an abnormally entering vehicle to a manager if the vehicle is abnormally entering the open storage yard.

12. The system of claim 2, wherein the management server checks whether information of entered vehicles previously registered for each open storage yard matches information of vehicles that are entering the open storage yard in real time, and provides a warning against an abnormally entering vehicle to a manager if the vehicle is abnormally entering the open storage yard.

13. The system of claim 5, wherein the management server checks whether information of shipped vehicles previously registered for each vessel matches information of vehicles that are being shipped in real time on the vessel, and provides a warning against an abnormally shipped vehicle to a manager if the vehicle is abnormally shipped.

14. The system of claim 6, wherein the management server checks whether information of shipped vehicles previously registered for each vessel matches information of vehicles that are being shipped in real time on the vessel, and provides a warning against an abnormally shipped vehicle to a manager if the vehicle is abnormally shipped.
